(19) United States
(12) Patent Application Publication
(10) Pub. No.: US 2022/0314349 A1
(43) Pub. Date: Oct. 6, 2022

(54) Skiving Tool and Method for Skiving Processing a Gear Wheel Blank

(71) Applicant: Präwema Antriebstechnik GmbH, Eschwege/Werra (DE)

(72) Inventors: Jörg Schieke, Erfurt-Marbach (DE); Walter Holderbein, Eschwege (DE); Jörg Reinhardt, Berka v.d.H. (DE)

(21) Appl. No.: 17/710,455

(22) Filed: Mar. 31, 2022

(30) Foreign Application Priority Data
Apr. 1, 2021 (DE) 10 2021 108 379.6

(51) Int. Cl. B23F 5/16; B23F 21/08

(52) U.S. Cl. CPC B23F 5/163; B23F 21/08

(57) ABSTRACT

The invention relates to a skiving tool which is designed as a disposable tool and which includes a first front side, a second front side, a toothing formed on its circumference and having teeth. The front surfaces assigned to the first front side are each delimited by a first cutting edge, as well as a coupling device for coupling the skiving tool to a tool spindle of a skiving machine. In order to enable an extended use in the case of such a skiving tool, the invention provides that the skiving tool has the basic shape of a cylindrical disc, that the front surfaces of the teeth assigned to the second front side are each delimited by a second cutting edge, and that the coupling device for use enables coupling of the skiving tool to the tool spindle such that the cutting edges assigned to its first front side come into engagement with the gear wheel to be processed, and enables coupling of the skiving tool to the tool spindle such that the cutting edges assigned to its second front side come into engagement with the gear wheel to be processed. During use, when the first cutting edges have reached their wear limit, the skiving tool is turned and skiving processing is continued with the same skiving tool until the second cutting edges have also reached their wear limit.

### CROSS-REFERENCE TO RELATED APPLICATION

This application claims priority to German Patent Application No. 10 2021 108 379.6 filed Apr. 1, 2021, the disclosure of which is hereby incorporated by reference in its entirety.

### BACKGROUND OF THE INVENTION

### Field of the Invention

The invention relates to a skiving tool. The skiving tool is designed as a disposable tool and comprises a first front side and a second front side, as well as a coupling device for coupling the skiving tool to a tool drive of a skiving machine. At the same time, the skiving tool comprises a toothing formed on its circumference and having teeth. The teeth each have a cutting edge, which, during use, comes into chip removing engagement with a gear wheel workpiece to be processed.

### Description of Related Art

The invention also relates to a method for skiving processing a gear wheel blank using such a skiving tool.

Skiving is a continuous chip removing process in which hobbing and shaping are combined by continuous rolling with axial feed. This results in a particular cost-effectiveness of skiving, which makes it possible to produce gear wheels in significantly shorter processing time. What is characteristic of skiving is the oblique arrangement of the axes of the tool and workpiece, as a result of which the axes of rotation of the tool and workpiece intersect at a so-called axis crossing angle. By the crossed axis arrangement, a relative speed between the tool and the workpiece is created. This relative movement is used as a cutting movement whose main cutting direction is aligned along the tooth gap of the workpiece.

The magnitude of the cutting speed depends on the size of the axis crossing angle and on the rotational speed of the processing spindles (see brochure “Wälzschälen—Power Skiving”, Issue August 2014, issued by the applicant and available for download at the URL “http://praewema.dvs-gruppe.com/uploads/tx_xpctypedownloadssimple/PRW_Power_Skiving.pdf”, retrieval date 31 Mar. 2021).

The tools used for skiving are naturally subject to wear, due to which they must be replaced after a certain period of use. In practice, therefore, such skiving tools designed as disposable tools and such skiving tools designed as reusable tools are used. Reusable tools have the advantage that once they have reached their wear limit, they can be reprocessed several times for reuse and thus meet the requirements for sustainable use of resources. However, for this option, higher acquisition costs and the costs of reprocessing must be accepted. Disposable tools are cheaper, but can no longer be used once the wear limit has been reached and must therefore be disposed of.

Against this background, the object has emerged to indicate a skiving tool and a method for skiving processing a gear wheel blank, which enable extended use also of skiving tools designed as disposable tools.

The invention has solved this object by a skiving tool which comprises at least the features as described herein and a method which comprises at least the work steps as described herein.

### SUMMARY OF THE INVENTION

Advantageous embodiments of the invention are indicated in the dependent claims and, like the general idea of the invention, are explained in detail in the following.

It goes without saying that, with regard to the method according to the invention, only the work steps are mentioned here, which are required to explain the particularities of the invention and the effects achieved thereby, and that it is assumed that the person skilled in the art, when carrying out the method according to the invention, independently supplements the work steps which he usually carries out in his daily practice when skiving processing gear wheel blanks.

In accordance with the prior art explained at the outset, a skiving tool according to the invention is designed as a disposable tool and comprises a first front side, a second front side, a toothing formed on its circumference and having teeth, in which the front surfaces assigned to the first front side are each delimited by a first cutting edge, which, during use, comes into chip removing engagement with a gear wheel to be processed, as well as a coupling device for coupling the skiving tool to a tool spindle of a skiving machine.

According to the invention, the skiving tool has the basic shape of a cylindrical disc.

Furthermore, in a skiving tool according to the invention, the front surfaces of the teeth of the toothing assigned to the second front side are each delimited by a second cutting edge.

Finally, the coupling device of a skiving tool according to the invention for use enables coupling of the skiving tool to the tool spindle of the respective skiving machine such that, during use, the cutting edges of its teeth assigned to its first front side come into engagement with the gear wheel to be processed, and enables coupling of the skiving tool to the tool spindle such that, during use, the cutting edges of its teeth assigned to its second front side come into engagement with the gear wheel to be processed.

A skiving tool according to the invention is thus designed in the manner of a reversible tool, which can be fastened to the tool spindle of a skiving machine in two positions.

For this purpose, a tool according to the invention has two identically designed processing sides, namely the first and the second front side, on which in each case cutters are provided, with which in each case the skiving processing can be carried out. At the same time, the coupling device is designed such that a skiving tool according to the invention for skiving use can be fastened to a tool holder of the respective skiving machine in arbitrary assignment of its front sides provided with the cutting surfaces.

This allows a skiving tool according to the invention, after it has reached the end of its service life and does not allow proper processing of the respective workpiece due to wear, to be turned and subsequently used again for skiving processing.

A method according to the invention for skiving processing a gear wheel blank accordingly comprises the following work steps:
a) providing a skiving tool designed as described herein;
b) coupling the skiving tool to a tool spindle of a skiving machine such that, during the skiving processing subsequently carried out (work step c)), the first cutting edges of the skiving tool assigned to the first front side of the skiving tool come into engagement with the gear wheel blank to be processed in each case;
c) skiving processing of gear wheel blanks until the first cutting edges of the skiving tool have reached a limit condition as a result of wear;
d) decoupling the skiving tool from the tool spindle;
e) turning the skiving tool and coupling the skiving tool to the tool spindle of the skiving machine such that, during the skiving processing subsequently carried out (work step f)), the second cutting edges of the skiving tool assigned to the second front side of the skiving tool come into engagement with the gear wheel blank to be processed in each case;
f) skiving processing of gear wheel blanks until the second cutting edges of the skiving tool have reached a limit condition as a result of wear.

With the invention, a skiving tool and method for skiving are thus provided, with which a doubling of the useful life also of such skiving tools, which are designed as disposable tools, can be achieved. The costs incurred by the design according to the invention compared to the manufacture of conventional disposable skiving tools are minimal, since no appreciable additional effort is required in the manufacture of the skiving tools according to the invention compared to the manufacture of conventional disposable skiving tools, except for the production of the cutters on the second front sides of the teeth of the tool.

This is achieved by the invention in that the skiving tool has the basic shape of a cylindrical disc, i.e. is formed such that its envelope is a cylinder.

A particularly simple design of a skiving tool according to the invention, which enables the ability to turn, results if the toothing of the skiving tool according to the invention is designed as a straight toothing with a symmetrical profile. The teeth of the toothing of the skiving tool then have a profile which is designed symmetrically with respect to the center plane of the skiving tool aligned normal to the axis of rotation and with respect to the center of the tooth.

A disposable tool according to the invention consists, for example, of a powder-metallurgically manufactured high-speed steel, already used for such applications in the prior art, in practice also referred to as “PM-HSS” or “HSS-PM”, or of a hard metal material also already used in practice for such applications.

An embodiment of the invention which is particularly important for practice is characterised in that the tooth head width of the teeth of the toothing of a skiving tool according to the invention is 2-20 mm. Skiving tools according to the invention, which are particularly suitable for practice, have a tooth head width of the teeth of its toothing of 4-7 mm.

The chipping surfaces of the cutters are preferably formed in a cone surface cut in order to achieve an optimal outflow of the chips produced during the skiving processing.

The coupling device, which is provided in the case of a skiving tool according to the invention and enables fastening independently of a special orientation of the front sides of the tool, can be formed by a through-opening extending from the first front side to the second front side. In this case, with a view to the ability to turn, a mouth region assigned to the first front side is practically designed mirror-symmetrically to a mouth region of the through-opening assigned to the second front side with respect to a center plane aligned normal to the longitudinal axis of the skiving tool and aligned centrally with respect to the width of the skiving tool measured parallel to the longitudinal axis of the skiving tool. In addition, for torsion-resistant coupling to the tool holder of the tool spindle of the respective machine tool, a form element for coupling of the skiving tool to the tool drive in a form-fitting and rotationally-fixed manner can be provided on an inner surface of the through-opening.

### BRIEF DESCRIPTION OF THE DRAWINGS

The invention is explained in more detail in the following by means of a drawing illustrating an exemplary embodiment. The Figures show schematically in each case:

FIG. 1 a skiving tool in perspective view;

FIG. 2 the skiving tool in a frontal view;

FIG. 3 the skiving tool in its side view.

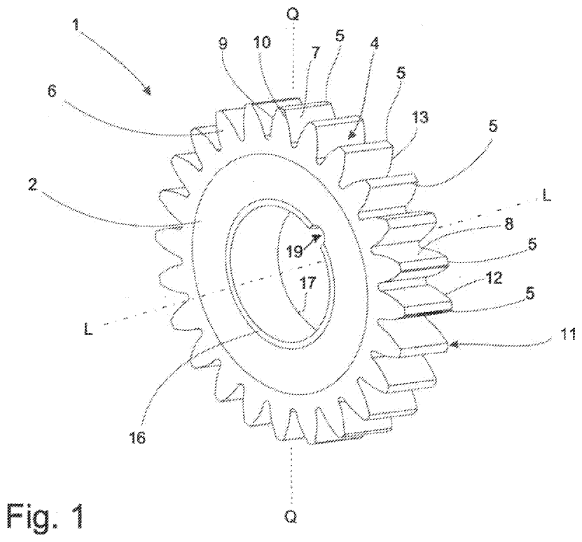

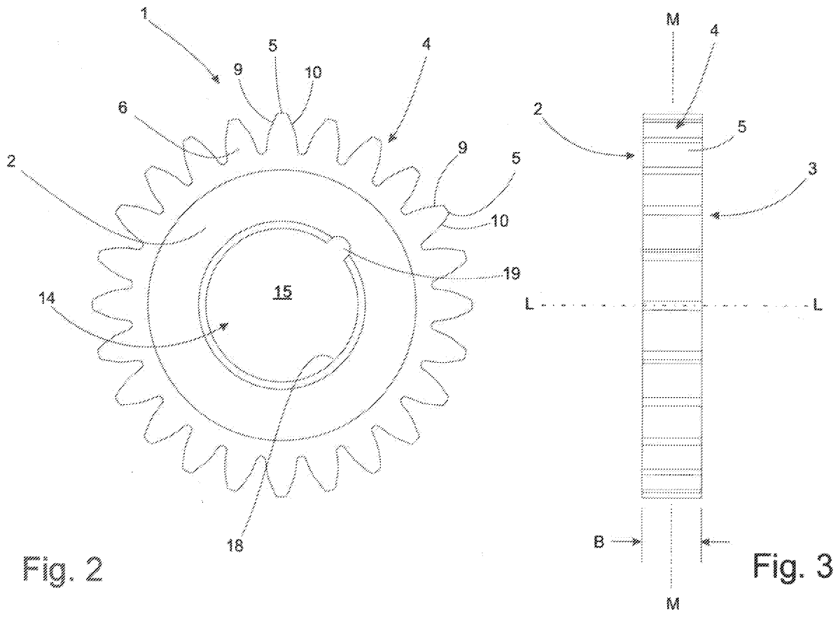

### DESCRIPTION OF THE INVENTION

The skiving tool 1 consisting of PM-HSS has the basic shape of a cylindrical disc and has a first front side 2 and a second front side 3 opposite the first front side 2.

On the circumference of the skiving tool 1, an external toothing 4 with teeth 5 is formed, which are arranged distributed in regular pitch around the central axis L which, during use, coincides with the axis of rotation of the skiving tool 1. Of course, it would also be possible to arrange the teeth of the skiving tool 1 in an irregular pitch if this were necessary to produce the toothing to be produced on the respective tooth blank.

The teeth 5 are straight-toothed and have a profile designed symmetrically with respect to the center plane M of the skiving tool 1 aligned normal to the axis L and with respect to the tooth center of the teeth 5.

The edges at which the front surfaces 6 of the teeth 5 of the external toothing 4 assigned to the first front side 2 of the skiving tool 1 coincide with the tooth flanks 7, 8 of the respective tooth 5 are designed as first cutting edges 9, 10.

Similarly, the edges at which the front surfaces 11 of the teeth 5 of the external toothing 4 assigned to the second front side 3 of the skiving tool 1 coincide with the tooth flanks 7, 8 of the respective tooth 5 are designed as second cutting edges 12, 13.

Depending on which of the front sides 2, 3 is, during use, facing the gear wheel blank to be processed, which is not shown here, one of the cutting edges 9, 10; 12, 13 in each case comes into engagement with the material of the gear wheel to be processed and removes said material. Due to the symmetrical shape of the teeth 5, all cutting edges 9, 10; 12, 13 produce the same shape on the teeth of the processed gear wheel blank.

The width B of the tooth heads of the teeth 5 of the skiving tool 1 is 6 mm in the example described here.

In order to enable the coupling to the spindle of a tool spindle of a skiving machine, which tool spindle is also not shown here, irrespective of which of the front sides 2, 3 of the skiving tool 1 is facing the gear wheel blank to be skiving processed in each case, the skiving tool 1 comprises a coupling device 14. This is formed by a central through-opening 15, which has a uniformly cylindrical basic shape and whose mouth regions 16, 17 adjoining the front sides 2, 3 are each designed mirror-symmetrically with respect to the center plane M of the skiving tool 1, which center plane M is aligned normal to the axis L. In this case, a recess 19 is formed into the inner circumferential surface 18 of the through-opening 15 as a form element for the rotationally-fixed coupling, which recess extends in an axis-parallel alignment with respect to the axis L from the first front side 2 to the second front side 3 of the skiving tool 1. During use, a correspondingly shaped projection of the tool spindle of the skiving machine not shown here engages into the recess 19, so that a secure, rotationally-fixed coupling of the skiving tool 1 and tool spindle is ensured.

For use, the skiving tool 1 is arranged in new condition on the tool spindle of the skiving machine, for example, such that its first front side 2 is assigned to the gear wheel blank to be processed in each case and the skiving processing is carried out with the first cutting edges 9, 10 assigned to the first front side 2. This processing continues until, after a certain number of skiving processed gear wheel blanks, the first cutting edges 9, 10 have reached a limit condition in which they are worn out by wear to such an extent that they no longer achieve a proper skiving result that meets the respective requirements.

Once this condition is reached, the skiving tool 1 is decoupled from the tool spindle of the machine tool and turned about an axis Q aligned transverse to the axis L such that its front side 3 is assigned to the gear wheel blank in each case pending processing. In this alignment, the skiving tool 1 is pushed back onto the spindle of the skiving machine and fastened there.

As with the first pass in which the front side 2 was assigned to the gear wheel blank to be processed in each case, the projection of the tool spindle, which engages into the recess 19 and is not shown here, ensures the rotationally-fixed coupling of the skiving tool 1.

During the skiving processing, which begins now, the material is removed by the second cutting edges 12, 13 of the skiving tool 1 assigned to the second front side 3.

Once these cutting edges 12, 13 have also reached their wear limit, the skiving tool 1 is decoupled from the tool spindle of the skiving machine and replaced by a similar new skiving tool.

Thus, the invention relates to a skiving tool 1, which is designed as a disposable tool and which comprises a first front side 2, a second front side 3, a toothing 4 formed on its circumference and having teeth 5, in which the front surfaces 6 assigned to the first front side 2 are each delimited by a first cutting edge 9, 10, as well as a coupling device 14 for coupling the skiving tool 1 to a tool spindle of a skiving machine. In order to enable extended use in the case of a skiving tool, the invention provides that the skiving tool 1 has the basic shape of a cylindrical disc, that the front surfaces of the teeth 5 assigned to the second front side are each delimited by a second cutting edge 12, 13, and that the coupling device 14 for use enables coupling of the skiving tool 1 to the tool spindle such that the cutting edges 9, 10 assigned to its first front side 2 come into engagement with the gear wheel to be processed, and enables coupling of the skiving tool 1 to the tool spindle such that the cutting edges 12, 13 assigned to its second front side 3 come into engagement with the gear wheel to be processed.

During use, when the first cutting edges 9, 10 have reached their wear limit, the skiving tool 1 is turned and skiving processing is continued with the same skiving tool 1 until the second cutting edges 12, 13 have also reached their wear limit. In this way, the duration for which a disposable skiving tool 1 according to the invention can be used is doubled compared to conventional disposable skiving tools.

### REFERENCE NUMERALS

1 Skiving tool
2 First front side of the skiving tool 1
3 Second front side of the skiving tool 1
4 External toothing of the skiving tool 1
5 Teeth of the external toothing 4
6 Front surfaces of the teeth 5 assigned to the first front side 2 of the skiving tool 1
7, 8 Tooth flanks of the teeth 5
9, 10 First cutting edges of the teeth 5
11 Front surfaces of the teeth 5 assigned to the second front side of the skiving tool 1
12, 13 Second cutting edges of teeth 5
14 Coupling device
15 Central through-opening of the skiving tool 1
16, 17 Mouth regions of the through-opening 15
18 Inner circumferential surface of the through-opening
19 Recess of the inner circumferential surface 18 (form element)
B Tooth head width of the teeth 5
Q Axis oriented transverse to the axis L
M Center plane of the skiving tool 1
L Central axis of the skiving tool 1

1. A skiving tool, which is designed as a disposable tool and which comprises a first front side, a second front side, a toothing formed on its circumference and having teeth, in which the front surfaces assigned to the first front side are each delimited by a first cutting edge, which, during use, comes into chip removing engagement with a gear wheel to be processed, as well as a coupling device for coupling the skiving tool to a tool spindle of a skiving machine, wherein the skiving tool has the basic shape of a cylindrical disc, in that the front surfaces of the teeth of the toothing assigned to the second front side are each delimited by a second cutting edge, and in that the coupling device for use enables coupling of the skiving tool to the tool spindle such that, during use, the cutting edges of its teeth assigned to its first front side come into engagement with the gear wheel to be processed, and enables coupling of the skiving tool to the tool spindle such that, during use, the cutting edges of its teeth assigned to its second front side come into engagement with the gear wheel to be processed.

2. The skiving tool according to claim 1,
wherein the toothing of the skiving tool is designed as a straight toothing with a symmetrical profile.

3. The skiving tool according to claim 1,
wherein the tooth head width of the teeth of its toothing is 2-20 mm.

4. The skiving tool according to claim 3,
wherein the tooth head width of the teeth of its toothing is 4-7 mm.

5. The skiving tool according to claim 1,
wherein the chipping surfaces of the cutting edges are formed in a cone surface cut.

6. The skiving tool according to claim 1,
wherein the coupling device is formed by a through-opening extending from the first front side to the second front side.

7. The skiving tool according to claim 6,
wherein a mouth region assigned to the first front side is designed mirror-symmetrically to a mouth region of the through-opening assigned to the second front side with respect to a center plane aligned normal to the longitudinal axis of the skiving tool and aligned centrally with respect to the width of the skiving tool measured parallel to the longitudinal axis of the skiving tool.

8. The skiving tool according to claim 7,
wherein a form element for coupling the skiving tool to the tool spindle of the respective skiving machine in a form-fitting and rotationally-fixed manner is provided at an inner surface of the through-opening.

9. A method for skiving processing a gear wheel blank, comprising the following work steps:
a) providing a skiving tool designed according to claim 1;
b) coupling the skiving tool to a tool spindle of a skiving machine such that, during the skiving processing subsequently carried out (work step c)), the first cutting edges of the skiving tool assigned to the first front side of the skiving tool come into engagement with the gear wheel blank to be processed in each case;
c) skiving processing of gear wheel blanks until the first cutting edges of the skiving tool have reached a limit condition as a result of wear;
d) uncoupling the skiving tool from the tool spindle;
e) turning the skiving tool and coupling the skiving tool to the tool spindle of the skiving machine such that, during the skiving processing subsequently carried out (work step f)), the second cutting edges of the skiving tool assigned to the second front side of the skiving tool come into engagement with the gear wheel blank to be processed in each case;
f) skiving processing of gear wheel blanks until the second cutting edges of the skiving tool have reached a limit condition as a result of wear.
